(19) United States
(12) Patent Application Publication
(10) Pub. No.: US 2024/0202435 A1
(43) Pub. Date: Jun. 20, 2024

(54) AUTOMATIC CROSS DOCUMENT CONSOLIDATION AND VISUALIZATION OF DATA TABLES

(71) Applicants: OHIO STATE INNOVATION FOUNDATION, Columbus, OH (US); University of South Carolina, Columbia, SC (US)

(72) Inventors: Goonmeet Kaur BAJAJ, Columbus, OH (US); Srinivasan Parthasarathy, Columbus, OH (US); Amit Sheth, Columbia, SC (US); Ugur Kursuncu, Columbia, SC (US)

(21) Appl. No.: 18/555,605

(22) PCT Filed: Feb. 16, 2022
(86) PCT No.: PCT/US2022/016552

§ 371 Date: Oct. 16, 2023

Related U.S. Application Data
(60) Provisional application No. 63/175,773, filed on Apr. 16, 2021.

(51) Int. Cl. G06F 40/177; G06F 40/194

(52) U.S. Cl. CPC G06F 40/177; G06F 40/194

(57) ABSTRACT

In an embodiment, a set of related documents (105) is selected (305). Each document may include at least one table of data (107). The tables may not include semantic or structural data that can be used to understand the data in the tables. Each table is processed to determine a schema for the table that includes a name and type for each column of the table (320). A consolidated schema is received for a consolidated table (320). The consolidated schema includes a name and type for each column of the consolidated table. The data from each table is extracted from the table and added to the consolidated table based on the schema associated with the table and the schema associated with the consolidated table (325). Later, the data in the consolidated table can be visualized to help identify one or more trends (400).

### CROSS-REFERENCE TO RELATED APPLICATIONS

This application claims priority to U.S. Provisional Patent Application No. 63/175,773, filed on Apr. 16, 2021, and entitled “AUTOMATIC CROSS DOCUMENT CONSOLIDATION AND VISUALIZATION OF DATA TABLES,” the disclosure of which is hereby incorporated by reference in its entirety.

### STATEMENT OF GOVERNMENT SUPPORT

This invention was made with government support under grant nos. 1761969 and 1761931 awarded by the National Science Foundation. The government has certain rights in the invention.

### BACKGROUND

Table extraction focuses on extracting tables in machine readable formats. However, no work exists to extract similar tables from similar documents. Data tables ubiquitously appear in financial reports, government reports, news articles, and scientific articles. In contrast to tables found on websites, where table elements can be tagged with hyperlinks to provide easy retrieval of relevant information, tables in PDF documents are often represented as vector or bitmap graphics with no structural and semantic information. As a result, simple use cases such as extracting data from tables to be used outside of the PDF reader or indexing tables for information search across documents can involve tedious additional work. Additionally, understanding tables require the reader to situate the table with the relevant text in the document and then refer to relevant content mentioned in the text. These cumbersome interactions interrupt the reading flow and can be cognitively demanding. The PDF format also makes it difficult to understand the changes in content over time.

It is with respect to these and other considerations that the various aspects and embodiments of the present disclosure are presented.

### SUMMARY

In an embodiment, a set of related documents is selected. Each document may include at least one table of data. The tables may not include semantic or structural data that can be used to understand the data in the tables. Each table is processed to determine a schema for the table that includes a name and type for each column of the table. A consolidated schema is received for a consolidated table. The consolidated schema includes a name and type for each column of the consolidated table. The data from each table is extracted from the table and added to the consolidated table based on the schema associated with the table and the schema associated with the consolidated table. Later, the data in the consolidated table can be visualized to help identify one or more trends.

In an embodiment, a method is provided. The method includes: receiving a plurality of documents by a computing device, wherein each document includes at least one table of a plurality of tables; identifying a subset of similar tables from the plurality of tables by the computing device; extracting data from each table in the subset of similar tables by the computing device; and consolidating the extracted data into a consolidated table by the computing device.

Embodiments may include some or all of the following features. The method may further include generating one or more visualizations using the consolidated table. Generating one or more visualizations using the consolidated table may include: receiving an indication of a variable of interest of the consolidated table; and generating the one or more visualizations based on the variable of interest. Each table of the plurality of tables is associated with metadata; and the method further includes identifying the subset of the similar tables from the plurality of tables based on the metadata. The metadata associated with each table may include one or more of a title of the table or a title of a document of the plurality of documents that the table was extracted from. The method may further include: receiving a consolidated schema for the consolidated table; and consolidating the extracted data into the consolidated table using the consolidated schema. The method may further include: for each table of the similar tables, determining a table schema for the table; and consolidating the extracted data into the consolidated table using the table schemas and the consolidated schema. Determining a table schema for the table may include determining the table schema using a machine learning model. The table schema for each table may include a name for each column of a plurality of columns of the table, and the consolidated table comprises a name for each column of a plurality columns of the consolidated table. Consolidating the extracted data into the consolidated table comprises, for each table of the plurality of tables may include: consolidating the extracted data from the table into the consolidated table by matching the names of the columns of the table with the names of the columns of the consolidated table. The plurality of documents may include PDF documents. The at least one table in each document of the plurality of documents may not include structural or semantic information about the contents of the tables.

In an embodiment, a system is provided. The system includes: at least one computing device; and a computer-readable medium with computer executable instructions that when executed by the at least one computing device cause the at least one computing device to: receive a plurality of documents, wherein each document includes at least one table of a plurality of tables; identify a subset of similar tables from the plurality of tables; extract data from each table in the subset of similar tables; consolidate the extracted data into a consolidated table; and generate one or more visualizations using the consolidated table.

Embodiments may include some or all of the following features. Generating one or more visualizations using the consolidated table includes: receiving an indication of a variable of interest of the consolidated table; and generating the one or more visualizations based on the variable of interest. Each table of the plurality of tables may be associated with metadata; and further comprising identifying the subset of the similar tables from the plurality of tables based on the metadata. The metadata associated with each table may include one or more of a title of the table or a title of a document of the plurality of documents that the table was extracted from. The computer executable instructions may further include computer executable instructions that cause the at least one computing device to: receive a consolidated schema for the consolidated table; and consolidate the extracted data into the consolidated table using the consolidated schema. The computer executable instructions may further include computer executable instructions that cause the at least one computing device to: for each table of the similar tables, determine a table schema for the table; and consolidate the extracted data into the consolidated table using the tables schemas and the consolidated schema. Determining a table schema for the table may include determining the table schema using a machine learning model.

In an embodiment, a non-transitory computer-readable medium is provided. The non-transitory computer-readable medium includes computer executable instructions that when executed by at least one computing device cause the at least one computing device to: receive a plurality of documents, wherein each document includes at least one table of a plurality of tables; identify a subset of similar tables from the plurality of tables; extract data from each table in the subset of similar tables; consolidate the extracted data into a consolidated table; and generate one or more visualizations using the consolidated table.

The embodiments described herein provide many advantages over the prior art. First, because of the PDF formatting used by documents, prior art methods for consolidating tables required users to manually copy table data from PDF documents into a consolidated table after first determining which columns of the tables correspond to the columns of the consolidated table. In contrast, the embodiments described herein automatically determine the schemas used for each table and use the schema of the consolidated table to quickly extract the data from each table column and deposit the extracted data into the corresponding columns in the consolidated table. Second, by easily consolidating table data, users such as analysts are able to quickly identify trends in the consolidated table that may not be evident when presented with each table by itself. Third, because the table data is consolidated without significant user input and effort from multiple documents, users may be able to quickly identify new trends in the consolidated data that may not have been easily identifiable from each document alone.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an environment for consolidating one or more tables and for generating one or more visualizations;

FIG. 2 is an illustration of example visualization;

FIG. 3 is an illustration of an example method for consolidating one or more tables;

FIG. 4 is an illustration of an example method for generating one or more visualizations; and

FIG. 5 shows an exemplary computing environment in which example embodiments and aspects may be implemented.

### DETAILED DESCRIPTION

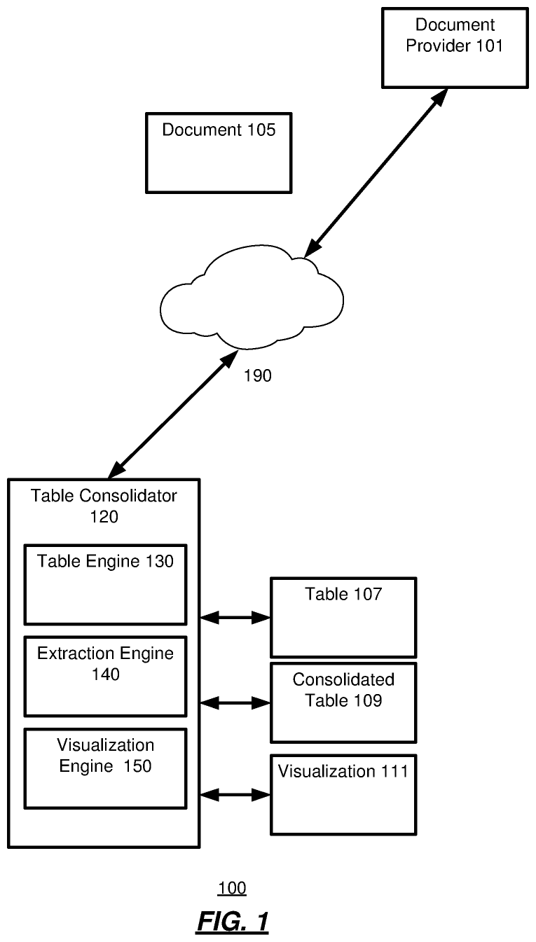

FIG. 1 is an example environment 100 for consolidating one or more tables and for generating one or more visualizations. As shown the environment 100 includes a document provider 101 in communication with a table consolidator 120 through a network 190. The network 190 may be a combination of public and private networks such as the internet. Other types of networks may be supported. Note while a network 190 is shown, it is for illustrative purposes only. The embodiments described herein are not limited to environments 100 that include networks.

The document provider 101 may provide one or more documents 105 through the network 190. Examples of document providers may include publishers, researchers, universities, and government entities. Any entity or individual capable of generating or publishing a document 105 may be considered a document provider 101. Alternatively, the document 105 may be provided locally via a disk or other computer-readable media.

The documents 105 may include a variety of document types in variety formats such as portable document format (“PDF”). Other formats may be supported. Examples of documents 105 include reports published periodically by one or more government agencies and financial documents published by one or more publicly traded companies.

The documents 105 may each include a plurality of tables 107. In general a table may include a plurality of columns and a plurality of rows. The intersection of a column and a row is referred to as a field. Each column may have a name and type that applies to all of the fields in the column. Each field in a row may be associated with the same entity or thing.

The structure of a table 107 may be defined by a schema. Generally, a schema for a table 107 describes the order of the columns in the table 107 along with the name of each column and type of data that is found in each column.

Unlike tables 107 found on web pages that include hyperlinks, the tables 107 in the documents 105 may not include any structural or semantic information about the contents of the tables 107. These tables 107 are often represented in the documents 105 using vector or bitmap graphics and do not include the names and types of each column. Thus, the schemas associated with each table 107 are unknown.

As may be appreciated, this causes several problems for readers who wish to make use of the data in these tables 107. First, because of the lack of structural or semantic information in a table 107, a reader has to refer to the text of the document 105 to understand the contents of the table 107. Second, for readers who may wish to combine the data from similar tables 107 across multiple documents 105, there is no easy way to extract the data quickly and efficiently from these tables 107 and combine them into a new table 107 or format. As a result, it may be difficult for readers to identify and summarize trends in the tables 107 across multiple formats.

For example, a police department of a town may generate a document 105 every year that includes various crime statistics for the town for the year including the number of burglaries, the number of assaults, the number of murders, etc. These statistics may be presented in one or more tables 107 in the document 105. A researcher may want to identify trends in the number of burglaries in the town over the last decade. Because of the lack of semantic and structural data in each document 105 for the tables 107, the researcher is forced to manually retrieve the document 105 published by the police department for each of the last ten years, identify the relevant data in each table 107 of each document 105, and copy the relevant data from each table 107 into a common table 107 or document 105. This process is made more difficult by the fact that often schema used the tables 107 in each document 105 may not be consistent, forcing the researcher to first standardize or convert the tables 107 using a common schema before combining.

Accordingly, to solve the problems noted above for tables 107 in documents 105, the environment 100 may include the table consolidator 120. The table consolidator 120 may receive a set of documents 105 from a user and may automatically identify related tables 107 in the documents 105. For each of the tables 107, the table consolidator 120 may automatically determine a schema used for each of the tables 107, and based on the determined schemas, may extract data from each of the tables and may place the extracted table into a consolidated table 109 based on a consolidated schema selected by the user or determined automatically. The consolidated table 109 may allow the user to easily view the consolidated data from the tables 107, identify trends in the consolidated data, and generate one or more visualizations 111 of the consolidated data.

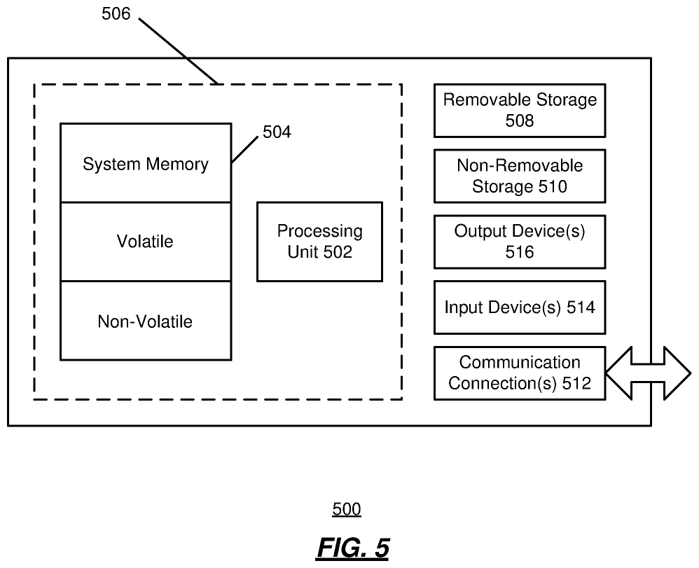

As shown, the table consolidator 120 has one or more components including, but not limited to, a table engine 130, an extraction engine 140, and a visualization engine 150. More or fewer components may be supported. Some or all of the components may be implemented together or separately using a general purpose computing device such as the computing device 500 illustrated in FIG. 5.

The table engine 130 may receive a plurality of documents 105. The documents 105 may be related documents 105 and may pertain to the same general subject or topic. Depending on the embodiment, the received documents 105 may be versions of the same report or publication regularly published by an entity such as a government agency, university, or corporation.

In some embodiments, the table engine 130 may receive the plurality of documents 105 from a user. The user may either provide the documents 105 to the table engine 130, or the user may identify where the documents 105 are located and the table engine 105 may retrieve the documents 105 from the document provider 101. The user may use a graphical user interface provided by the table engine 130 to select the documents 105.

In some embodiments, the table engine 130 may identify the plurality of documents 105 for the user. For example, the user may provide a first document 105 to the table engine 130, and the table engine 130 may determine other documents 105 that are likely similar or related to the provided first document 105. The table engine 130 may determine similar documents 105 using document features such as titles, authors, and associated document providers 101. In addition, the table engine 130 may identify similar documents 105 using a model trained (e.g., using machine learning) to identify similar documents 105. Any method for identifying similar documents 105 may be used.

The table engine 130 may identify one or more similar tables 107 in the documents 105. The table engine 130 may first identify all tables 107 in each of the documents 105. Depending on the embodiment, the table engine 130 may identify tables looking for structures in the document 105 that are associated with tables 107 such as columns, rows, and fields. In addition, the table engine 130 may use OCR or other text processing to location words in the document 105 that are associated with tables 107 such as “table”, “chart”, “results”, and “data”. Any method for identifying tables 107 in documents may be used.

Once the table engine 130 has identified the tables 107 in a document 105 or documents 105, the table engine 130 may ask or prompt a user to select a table 107 that they are interested in consolidating with similar tables 107 from the similar documents 105. For example, the table engine 130 may prompt the user to select a table 107 using the graphical user interface used by the user to select the similar documents 105.

The table engine 130 may identify tables 107 among the tables 107 of the similar document 105 that are similar to the selected table 107. Depending on the embodiment, the table engine 130 may identify similar tables 107 based on information such as the titles of the tables 107, text in the corresponding documents 105 that is near each table 107, the locations of each table 107 in the corresponding document 105, and characteristics or features of the tables 107 (e.g., number of rows or columns, and the name of each column). Other information may be included. This information about each table 107 is referred to herein as metadata.

In some embodiments, the table engine 130 may use a model to identify similar tables 107. The model may take as an input two tables 107 (or metadata from each table 107) and may output a similarity score that indicates how similar each table 107 is. The model may be trained using machine learning, for example. Other types of models may be used.

The extraction engine 145 may extract data from each of the similar tables 107 and may combine the extracted data into what is referred to herein as a consolidated table 109. The extraction engine 140 may combine the extracted data into the consolidated table 109 using schemas associated with each of the similar tables 107 and a schema associated with the consolidated table 109.

In some embodiments, the extraction engine 140 may first determine the schema associated with each table of the similar tables 107. As described above, because of the nature of the documents 105, there may be no schema provided for each similar table 107. Accordingly, the extraction engine 140 may generate a schema for each table 107. In some embodiments, the extraction engine 140 may generate the schema for table 107 using the metadata associated with the table 107. For example, the extraction engine 140 may use the title of each column (i.e., the entry for the column in the first row of the table 107) to determine the names for each column in the schema for the table. The extraction engine 140 may look for data in each column to infer the type of the table such as number or currency symbols. Where the table engine 130 is unable to determine the schema for a table 107, or for a particular column of the table 107, the extraction engine 140 may prompt the user to provide input into the schema. For example, the extraction engine 140 may prompt the user using the graphical user interface.

In some embodiments, the extraction engine 140 may use a model to determine the schema for a table 107. The model may receive as an input a table 107 and may output a schema for the table 107. The output may include a probability for each column of the schema. If the probability for a particular column (e.g., type and name) is below a threshold, the extraction engine 140 may prompt the user for clarification or approval. The model may be trained using machine learning or other model training techniques.

The extraction engine 140 may further generate a schema for the consolidated table 109. In some embodiments, the schema for the consolidated table 109 may be based on the schemas of the similar tables 107. Because some tables had their columns in different orders than other tables 107, or some tables 107 included one or more additional columns, the schema for the consolidated table 109 may be different than the schema of any particular table 107.

Depending on the embodiment, the extraction engine 140 may generate the consolidated table 109 from the similar tables 107 in the selected documents 105 using the following Algorithm 1:

Algorithm 1: Consolidating Data Tables
consolidate_tables = { }
for title, schema in zip(table_titles, schemas) do
| consolidate_tables[title] = create_table(schema)
end
for doc in Documents do
| for table in doc.tables do
| | table_type = get_table_type(table);
| | consolidate_tables = parse_tables(table,
| | table_table):
| end
end
return consolidate_tables

In some embodiments, rather than construct the schema for the consolidated table 109, the extraction engine 140 may prompt the user to provide a schema for the consolidated table 109. For example, the extraction engine 140 may present an example schema for the consolidated table 109 to the user in the graphical user interface. The example schema may be based on one or more of the schemas determined for the tables 107. The user may then add or remove columns from the example schema, change the order of the columns in the schema, or may rename one of the columns in the schema.

The extraction engine 140 may create the consolidated table 109 by mapping the data from the each table 107 to the consolidated table 109 using the schemas of each table 107 and the schema of the consolidated table 109. For example, for a hypothetical set of documents 105 related to illegal drug prices in different cities and years, according to a schema a table 107 may include a first column titled “drug name”, a second column titled “price”, and a third column titled “amount”. The consolidated table 109 may include a second column titled “drug name”, a second column titled “amount”, and a third column titled “price”. Accordingly, based on the schema, the extraction engine 140 may map the first column of the table 107 to the first column of the consolidated table 109, may map the second column of the table 107 to the third column of the consolidated table 109, and may map the third column of the table 107 to the second column of the consolidated table 109.

As may be appreciated, sometimes when mapping the tables 107 to the consolidated table 109, the consolidated table 109 may have more or fewer columns than a table 107. When the consolidated table 109 has fewer columns than table 107, the extraction engine 140 may discard the extraneous column from the table 107. When the consolidated table 109 has more columns than a table 107, the extraction engine 140 may add blank or null values to the consolidated table 109.

Alternatively, in some implementations, when the consolidated table 109 has more columns than a table 107, the extraction engine 140 may construct or fill in the data corresponding to the consolidated table 109. The missing data may be based on metadata associated with the document 105 or the table 107.

For example, a user may be constructing a consolidated table 109 related to the price of Suboxone in different cities and reporting periods. A table 107 for Cleveland, Ohio may be associated with a schema with a first column titled “dosage”, a second column titled “price”, and a third column titled “reporting period”. A table 107 for Columbus, Ohio may also be associated with a schema with a first column titled “dosage”, a second column titled “price”, and a third column titled “reporting period”. The consolidated table 109 may be associated with a schema with a first column titled “dosage”, a second column titled “price”, a third column titled “reporting period”, and a fourth column titled “City.”

As can be seen in the above example, neither the schemas for the tables 107 for Columbus or Cincinnati have a column related to city. However, when mapping the tables 107 to the consolidated table 107, the extraction engine 140 may infer from the title of each table 107 their respective city names and may use these city data to fill in the data of the fourth column when mapping each table 107 to the consolidated table 109. Depending on the embodiment, the extraction engine 140 may infer the values for the missing columns based on the metadata of the table 107 and/or the associated document 105 or may use input from the user to infer the values.

The consolidated table 109 may be useful on its own for a variety of purposes. However, to allow the user (or reader) to quick identify trends in the data of the consolidated table 109, the table consolidator 120 may include the visualization engine 150. The visualization engine 150 may generate one or more visualizations 111 based on the consolidated table 109. The visualizations 111 may include graphs and charts and may be generated by the visualization engine 150 based on the data in the consolidated table 109. Any method for generating a visualization 111 may be used.

In some embodiments, the user may indicate one or more variables of interest, and the visualization engine 150 may generate the visualization 111 based on the indicated variable of interests. For example, the user may indicate particular columns of the consolidated table 109 and a date range that they would like to use for a visualization 111. The user may indicate the variables of interest through a graphical user interface provided by the visualization engine 150. As may be appreciated the visualizations 111 of the consolidated table 109 may allow the user (and readers) to identify trends in the data from the various tables 107 that may not have been apparent or easily recognized before the data was consolidated into the consolidated table 109.

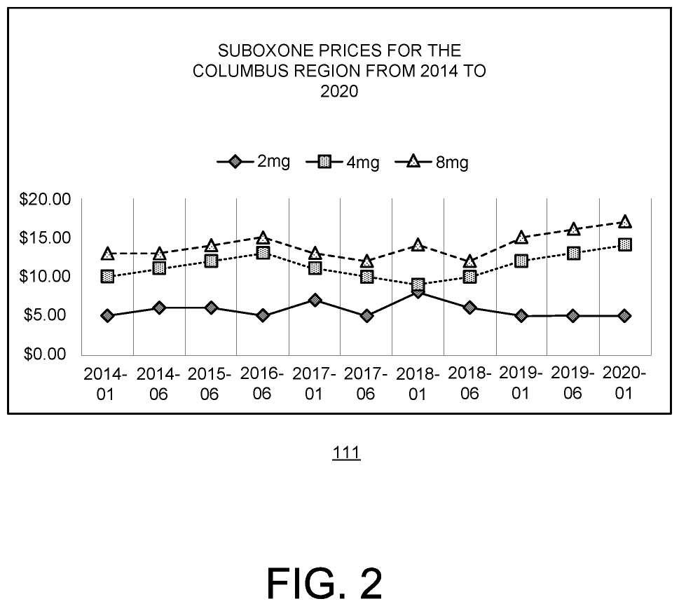

FIG. 2 is an illustration of an example visualization 111 that can be generated by the visualization engine 150. In the example shown, the visualization 111 is of “Suboxone prices from the Columbus region from 2014 to 2020.” Continuing the Suboxone example above, the user may have selected from the consolidated table 109 variables of interest including “price” and the “dosages” of 2 mg, 4 mg, and 8 mg. The user may have also selected variables of interest including the date range of 2014-01 (i.e., January 2014) through 2020-01 (i.e., January 2020) and entries in the consolidated table 109 that are associated with the “region” of Columbus.

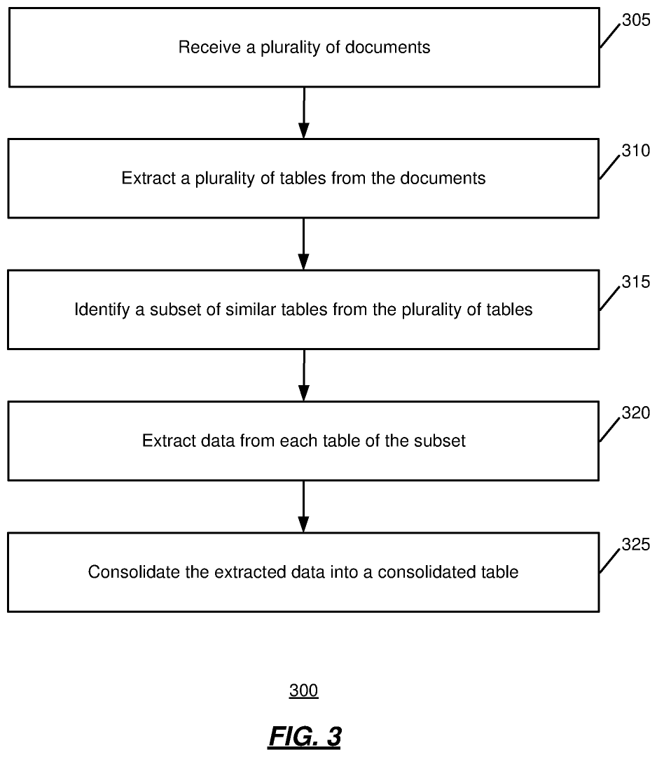

FIG. 3 is an illustration of an example method 300 for consolidating one or more tables 107. The method 300 may be implemented by the table consolidator 120.

At 305, a plurality of documents is received. The plurality of documents may be received by the table engine 130. The documents 105 of the plurality of documents may be similar or related documents. For example, the documents 105 may be different versions of the same government report or publication for different years or different regions of a country. Each document 105 may include one or more tables 107. Each document 105 may be rendered in a format (e.g., PDF) such that semantic or structural information about the content of the tables 107 is not available. The documents 105 may be identified by, or provided by, a user.

At 310, a plurality of tables is extracted from the documents. The tables 107 may be extracted from each of the documents 107. Any method for extracting tables from documents 107 may be used.

At 315, a subset of similar tables is identified from the plurality of tables. The subset of similar tables 107 may be identified by the table engine 130. In some embodiments, the user may select a table 107 that they are interested in and the table engine 130 may identify tables 107 for the subset that are similar to the selected table. Alternatively, the table engine 130 may identify all sets of similar tables that are found in the documents 105.

In some embodiments, the table engine 130 may identify similar tables 107 using information about each table 107 such as metadata. This may include the number of columns in each table 107, the titles or names of each column, the title or name of the table 107 in its associated document 105, and the location of table 107 in its associated document 105. Other information may be considered. In addition, the table engine 130 may use a model trained to output the similarity of two tables 107 to identify similar tables 107.

At 320, data is extracted from each table of the subset of tables. The data may be extracted from each table 107 by the extraction engine 140. Any method for extracting data may be used.

At 325, the extracted data is consolidated into a consolidated table. The extracted data may be consolidated into a consolidated table 109 by the extraction engine 140. In some embodiments, the extraction engine 140 may consolidate the data into the consolidated table 109 by first receiving a consolidated schema for the consolidated table 109. The consolidated schema may indicate the order, title, and type of each column in the consolidated table 109. The consolidated schema may be provided by the user.

The extraction engine 140 may similarly determine a schema for each table 107 in the set of similar tables. The schema for each table 107 may be provided by the user or may be determined automatically by the extraction engine 150 based on information in each table such as the entries in the first row of each table 107, or the metadata associated with the each table 107. Any method for inferring the schema of a table 107 based on the data in the table 107 may be used.

The schemas from each table 107 and the consolidated table 109 may be used to generate a mapping from the columns of each table 107 to the columns of the consolidated table 109. The extracted data from each table 107 may be placed into the consolidated able 109 according to the mapping.

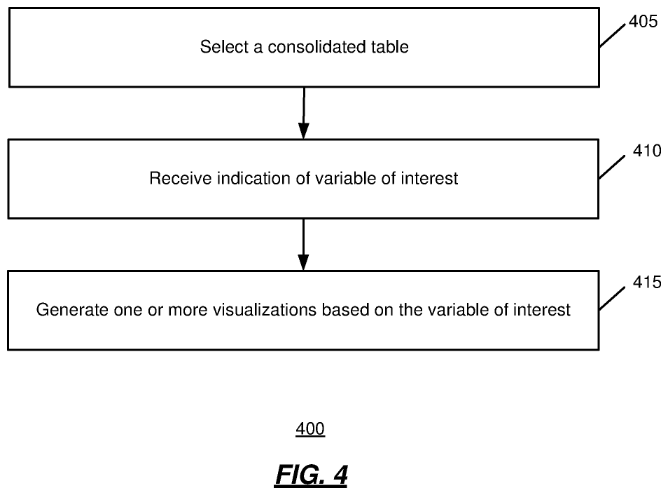

FIG. 4 is an illustration of an example method for generating one or more visualizations from a consolidated table. The method 400 may be implemented by the visualization engine 150.

At 405, a consolidated table is selected. The consolidated table 109 may be selected by a user who wishes to visualize some aspect of the consolidated table 109. In some embodiments, the consolidated table 109 may be selected by the user using a graphical user interface provided by the visualization engine 150.

At 410, an indication of a variable of interest is received. The indication of the variable of interest may be received by the visualization engine 150 from the user. In some embodiments, the variable of interest may include one or more columns of the consolidated table 109, date ranges, and particular field values from the consolidated table 109. The user may also provide information that will be used to generate the one or more visualizations 111. This information may include a selection of the type of visualization 111 (e.g., table, chart, or graph), assignments of columns or variables to axes, and selections of scales to use for various aspects of the visualizations 111.

At 415, one or more visualizations are generated based on the variable of interest. The one or more visualization 111 may be generated by the visualization engine 150. Depending on the embodiment, the one or more visualizations 111 may be displayed to the user in the graphical user interface provided by the visualization engine 150, for example.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a plurality of documents by a computing device, wherein each document includes at least one table of a plurality of tables;
identifying a subset of similar tables from the plurality of tables by the computing device;
extracting data from each table in the subset of similar tables by the computing device; and
consolidating the extracted data into a consolidated table by the computing device.

2. The method of claim 1, further comprising generating one or more visualizations using the consolidated table.

3. The method of claim 2, wherein generating one or more visualizations using the consolidated table comprises:
receiving an indication of a variable of interest of the consolidated table; and
generating the one or more visualizations based on the variable of interest.

4. The method of claim 1, wherein each table of the plurality of tables is associated with metadata; and further comprising:
identifying the subset of the similar tables from the plurality of tables based on the metadata.

5. The method of claim 4, wherein the metadata associated with each table comprises one or more of a title of the table or a title of a document of the plurality of documents that the table was extracted from.

6. The method of claim 1, further comprising:
receiving a consolidated schema for the consolidated table; and
consolidating the extracted data into the consolidated table using the consolidated schema.

7. The method of claim 1, further comprising:
for each table of the similar tables, determining a table schema for the table; and
consolidating the extracted data into the consolidated table using the table schemas and the consolidated schema.

8. The method of claim 7, wherein determining a table schema for the table comprises determining the table schema using a machine learning model.

9. The method of claim 7, wherein the table schema for each table comprises a name for each column of a plurality of columns of the table, and the consolidated table comprises a name for each column of a plurality columns of the consolidated table.

10. The method of claim 9, wherein consolidating the extracted data into the consolidated table comprises, for each table of the plurality of tables comprises:
consolidating the extracted data from the table into the consolidated table by matching the names of the columns of the table with the names of the columns of the consolidated table.

11. The method of claim 1, wherein the plurality of documents comprises PDF documents.

12. The method of claim 1, wherein the at least one table in each document of the plurality of documents does not include structural or semantic information about the contents of the tables.

13. A system comprising:
at least one computing device; and
a computer-readable medium with computer executable instructions that when executed by the at least one computing device cause the at least one computing device to:
receive a plurality of documents, wherein each document includes at least one table of a plurality of tables;
identify a subset of similar tables from the plurality of tables;
extract data from each table in the subset of similar tables;
consolidate the extracted data into a consolidated table; and
generate one or more visualizations using the consolidated table.

14. The system of claim 13, wherein generating one or more visualizations using the consolidated table comprises:
receiving an indication of a variable of interest of the consolidated table; and
generating the one or more visualizations based on the variable of interest.

15. The system of claim 13, wherein each table of the plurality of tables is associated with metadata; and further comprising:
identifying the subset of the similar tables from the plurality of tables based on the metadata.

16. The system of claim 15, wherein the metadata associated with each table comprises one or more of a title of the table or a title of a document of the plurality of documents that the table was extracted from.

17. The system of claim 13, further comprising:
receiving a consolidated schema for the consolidated table; and
consolidating the extracted data into the consolidated table using the consolidated schema.

18. The system of claim 13, further comprising:
for each table of the similar tables, determining a table schema for the table; and
consolidating the extracted data into the consolidated table using the tables schemas and the consolidated schema.

19. The system of claim 18, wherein determining a table schema for the table comprises determining the table schema using a machine learning model.

20. A non-transitory computer-readable medium with computer executable instructions that when executed by at least one computing device cause the at least one computing device to:
receive a plurality of documents, wherein each document includes at least one table of a plurality of tables;
identify a subset of similar tables from the plurality of tables;
extract data from each table in the subset of similar tables;
consolidate the extracted data into a consolidated table; and
generate one or more visualizations using the consolidated table.
